(19) United States
(12) Patent Application Publication
(10) Pub. No.: US 2009/0113285 A1
(43) Pub. Date: Apr. 30, 2009

(54) FORM INPUT SUPPORT METHOD AND FORM INPUT SUPPORT APPARATUS

(75) Inventor: Kenji ISHII, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/251,838

(22) Filed: Oct. 15, 2008

(30) Foreign Application Priority Data
Oct. 24, 2007 (JP) 2007-276440

(51) Int. Cl. G06F 3/01

(52) U.S. Cl. 715/221

(57) ABSTRACT

An form input support method for supporting to input data in a form-input-page displayed as a web page, wherein a screen storage function unit comprises a step for storing screens to store the form-input-page displayed as the web page, a data edit function unit comprises a step for editing data to display the form-input-page stored by the step for storing screens in an offline state and stores the data to be transmitted input in each input item in relation to the form-input-page, a data paste function unit comprises a step for taking out the data to be transmitted stored in relation to the form-input-page in the step for editing data, and for pasting and displaying the data to be transmitted in an input item of a corresponding form-input-page displayed as a web page in the online state.

### CROSS-REFERENCE TO RELATED APPLICATION

This application is based upon and claims the benefit of priority of the prior Japanese Patent Application No. 2007-276440, filed on Oct. 24, 2007, the entire contents of which are incorporated herein by reference.

### BACKGROUND OF THE INVENTION

1. Field

An aspect of the invention is related to a form input support method and a form input support apparatus more specifically to a form input support method, a form input support apparatus, and a form input support program for providing a function for supporting data input in a form-input-page which is displayed as a web page.

2. Description of the Related Art

A so-called form-input-page is used for shopping or inputting a blog using a web browser of a personal computer.

This form-input-page is a page made up of, for example, HTML, and has constitution that the data input in input items is uploaded onto a server by a HTTP request by performing an operation for inputting appropriate input items in each input item field which is set on this form-input-page.

Use of the form-input-page is generally based on real time use.

For example, if a user attempts to continue processing for inputting data in the form-input-page while the form-input-page is displayed for a long time on a shopping site, a session disconnection occurs and the data which has been input until that moment becomes invalid.

For example, a so-called My Profile function is known as a support method for inputting personal information such as home address. The My Profile function allows a user to paste the profile information registered with the mobile phone on a My Profile-compliant form-input-page by simply clicking one button.

When, for example, a user creates a blog on the browser of the mobile phone, the form-input-page is used to input necessary information. In general, although a user takes time to input data when creating a blog, the blog has to be created within a short time to prevent session disconnection.

Further, when a blog is created in this manner, after the information is input by using the form-input-page, if uploading the information onto the server for registration fails, the information which has been input until that moment may be lost.

Therefore, there is a method considered in the case of using such service. In this method, contents to be input are made in advance separately, and the contents made in this manner are pasted on the form-input-page displayed on a web page.

In general, when the browser of the mobile phone is used, the contents to be input are made in advance as described above. To paste the contents to be input on the form-input-page displayed as a web page, the contents to be input are made by using a function such as a so-called text memo. Then a so-called copy-and-paste operation is performed to paste the contents in appropriate input fields of the form-input-page displayed as a web page. (See, for example, [Patent Document] Japanese Laid-Open Patent Publication No. 2004-112115).

### SUMMARY

Accordingly, it is an object of the invention to provide a constitution for supporting to input data in a form-input-page, which is in particular displayed as a web page, having constitution for inputting the data to be transmitted in each input item.

According to an aspect of the invention, a method includes a form input support method for supporting to input data in a form-input-page displayed as a web page, in constitution for inputting data to be transmitted in each input item, wherein a screen storage function unit comprises a step for storing screens to store the form-input-page displayed as the web page, a data edit function unit comprises a step for editing data to display the form-input-page stored by the step for storing screens in an offline state and stores the data to be transmitted input in each input item in relation to the form-input-page, a data paste function unit comprises a step for taking out the data to be transmitted stored in relation to the form-input-page in the step for editing data, and for pasting and displaying the data to be transmitted in an input item of a corresponding form-input-page displayed as a web page in the online state.

### BRIEF DESCRIPTION OF THE DRAWINGS

FIG. 1 is a function block diagram illustrating a form registration unit, a form editing unit, and a form using unit included in a mobile phone according to an embodiment of the present invention;

FIG. 2 is a diagram showing a hierarchical structure of software of the mobile phone according to an embodiment of the present invention;

FIG. 3 is a diagram showing a browser menu of the mobile phone according to an embodiment of the present invention;

FIG. 4 is a diagram illustrating a function of the form registration unit of the mobile phone according to an embodiment of the present invention;

FIG. 5 is a diagram illustrating a function of the form editing unit of the mobile phone according to an embodiment of the present invention;

FIG. 6 is a diagram illustrating an example of the information stored in a form DB and a data DB by a function of an example of the form editing unit shown in FIG. 5;

FIG. 7A is a diagram illustrating an example of the information stored in the form DB by a function of another example of the form editing unit shown in FIG. 5;

FIG. 7B is a diagram illustrating an example of the information stored in the form DB by a function of another example of the form editing unit shown in FIG. 5;

FIG. 8 is a diagram illustrating a function of the form using unit of the mobile phone according to an embodiment of the present invention;

FIG. 9 is a processing flowchart (1) illustrating a flow of processing for displaying a site on the mobile phone according to an embodiment of the present invention;

FIG. 10 is a processing flowchart (2) illustrating a flow of processing for displaying a site on the mobile phone according to an embodiment of the present invention;

FIG. 11 is a processing flowchart (3) illustrating a flow of processing for displaying a site on the mobile phone according to an embodiment of the present invention;

FIGS. 12A and 12B illustrate a processing flowchart (1) illustrating an operation for displaying each screen on the mobile phone and a flow of processing for displaying each screen thereof according to an embodiment of the present invention;

FIG. 13 is a processing flowchart (2) illustrating an operation for displaying each screen on the mobile phone and a flow of the processing for displaying each screen thereof according to an embodiment of the present invention;

FIG. 14 is a processing flowchart illustrating a flow of processing for performing a function of the form registration unit of the mobile phone according to an embodiment of the present invention;

FIG. 15 is a processing flowchart (1) illustrating a flow of processing for performing a function of the form editing unit of the mobile phone according to an embodiment of the present invention;

FIG. 16 is a processing flowchart (2) illustrating a flow of processing for performing a function of the form editing unit of the mobile phone according to an embodiment of the present invention;

FIGS. 17A and 17B illustrate a processing flowchart illustrating an operation for performing a function of the form function unit of the mobile phone and a flow of the processing for performing the function thereof according to an embodiment of the present invention;

FIG. 18A is a processing flowchart illustrating an operation for performing a function of the form using unit of the mobile phone according to an embodiment of the present invention;

FIG. 18B is (Please provide description here); and

FIG. 19 is a hardware block diagram of a computer illustrating the case when the form registration unit, the form editing unit, and the form using unit comprised in the mobile phone are achieved by the computer comprised in the mobile phone.

### DETAILED DESCRIPTION OF THE EMBODIMENTS

According to constitution of the present invention, a form-input-page displayed as a web page is stored; the form-input-page stored in this manner is displayed in an offline state, and data to be transmitted input in each input item is stored in relation to the form-input-page. Therefore, a user can take long enough to input the data to be transmitted in each input item on the form-input-page displayed in the offline state.

Accordingly, the user can perform an operation for inputting data as if the user inputs the data to be transmitted in each input item of the form-input-page displayed as a web page in an online state. In this case, since the form-input-page is displayed in the offline state, the user can take as long as needed to perform the operation for inputting the data without having to worry about session disconnection. Consequently, the user-friendliness is improved.

The operation for inputting the data to be transmitted is performed as described above. After the operation is completed, the data to be transmitted is stored in relation to an appropriate form-input-page. Then the data to be transmitted stored in relation to the form-input-page is taken out. The data to be transmitted is pasted and displayed in input items of a corresponding form-input-page displayed as a web page in the online state.

As a result, the stored data to be transmitted is pasted and displayed in each input item of the corresponding form-input-page displayed in the online state, respectively. This processing includes processing for matching the input items between the form-input-page displayed in the online state and the stored data to be transmitted, and processing for pasting and displaying the stored data to be transmitted in the input items of the form-input-page displayed in the online state according to the matching results. Therefore, the processing can be completed within a very short time, so that there is no possibility of session disconnection.

In this case, the processing for pasting and displaying the stored data to be transmitted in the corresponding form-input-page displayed in the online state can be performed, for example, in input item units of a name attribute of a form-input-page which is made into an HTML format.

That is, the stored data to be transmitted is taken out to generate a list of the input item units. Then the data to be transmitted is collated with the input items of the appropriate name attribute of the corresponding form-input-page displayed as a web page in the online state. As for the input items collated between the data to be transmitted in the list form and the corresponding form-input-page displayed as a web page in the online state, the data to be transmitted is pasted and displayed in the corresponding input items of the form-input-page displayed as a web page in the online state.

In an embodiment of the present invention, the contents to be input in the form-input-page can be made in advance. By an operation with a function of the browser of the mobile phone, the contents made in advance in this manner can be easily pasted and displayed in the form-input-page displayed in the online state.

Moreover, a screen for making the contents to be input in the form-input-page, made in advance, can be displayed by using the web data of the corresponding form-input-page.

Further, making and editing the contents to be input in the form-input-page, made in advance, can be interrupted and restarted as needed.

Furthermore, the contents to be input in the form-input-page, made in advance, can be pasted and displayed in the form-input-page displayed as a web page in the online state by a simple operation.

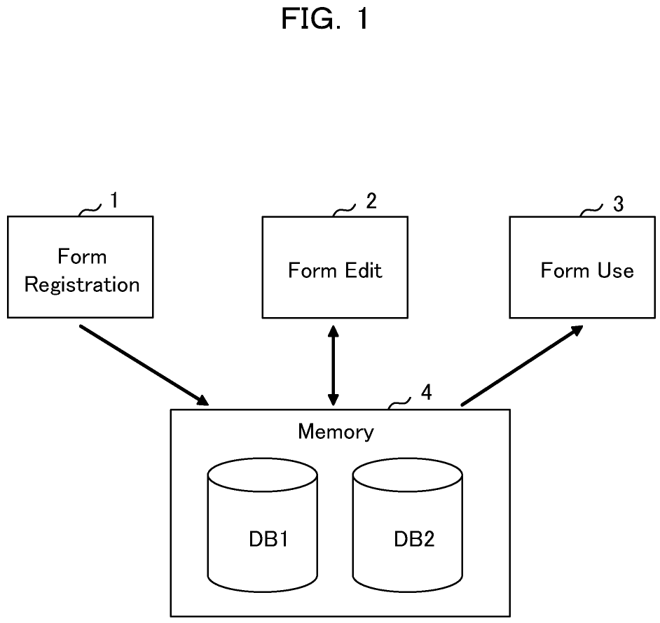

That is, as shown in FIG. 1, the mobile phone according to an embodiment of the present invention includes, a form registration unit 1 providing a function for storing a form-input-page displayed as a web page in a form DB and a form DB1 of a memory 4 therein, a form editing unit 2 providing a function such as for displaying, editing, and restoring the stored form-input-page and the data to be transmitted input by a user, stored in a data DB and a data DB2 of the memory 4, and a form using unit 3 providing a function for pasting and displaying the data to be transmitted stored in the data DB and the data DB2 in the form-input-page displayed as a web page on the browser of the mobile phone.

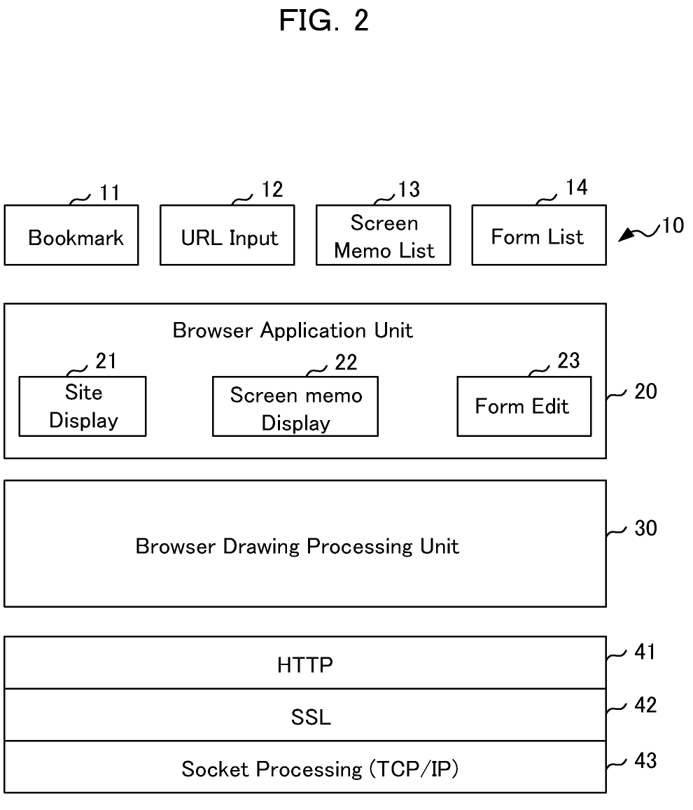

FIG. 2 shows a hierarchical structure of software loaded on the mobile phone according to an embodiment of the present invention.

In FIG. 2, a top layer 10 includes a bookmark function unit 11, a URL input function unit 12, a screen memo list function unit 13, and a form list function unit 14.

The bookmark function unit 11 is a functional part which provides a well-known bookmark function.

The URL input function unit 12 is a functional part which provides a function for connecting to an appropriate site to display a web page provided by the site when a user inputs a URL.

The screen memo list function unit 13 is a functional part which provides a function for displaying a list of screens stored by a well-known screen memo function.

The form list function unit 14 is a functional part which includes the form editing unit 2 and the form using unit 3, and is a functional part for displaying a list of a plurality of the form-input-pages stored in the form DB and the form DB1 by the function of the form registration unit 1.

Furthermore, a browser application unit 20 is provided in a lower layer. Of the functions of the browser included in the mobile phone, the browser application unit 20 is a functional part which provides a function for obtaining information to be displayed on a display screen of the mobile phone.

The browser application unit 20 includes a site display function unit 21, a screen memo display function unit 22, and a form editing function unit 23.

The site display function unit 21 is an application program which provides a function for connecting to the site specified by the bookmark function unit 11 in order to display the web page provided by the site.

Of the screens displayed in the list of the screen memo list function unit 13, the screen memo display function unit 22 is an application program which provides a function for displaying the screen specified by the user.

The form editing function unit 23 is a functional part included in the form editing unit 2. It is an application program wherein the form-input-page is displayed in the offline state with respect to the form specified by the user from the list displayed by the form list function unit 14, and the data to be transmitted is pasted and displayed in corresponding input item fields of the form-input-page displayed in the offline state if the corresponding data to be transmitted is stored in the data DB and the data DB2. This function allows the user to edit the data to be transmitted.

A browser drawing processing unit 30 is provided in a lower layer of the browser application unit 20. The browser drawing processing unit 30 is a functional part which performs processing for actually displaying images on the display screen of the mobile phone based on the information to be displayed obtained by the function of the browser application unit 20. Specifically, the browser drawing processing unit 30 performs drawing processing in the case such as when the site display function unit 21 displays a web page, when the screen memo display function unit 22 displays a screen, and when the form editing function unit 23 displays a form-input-page.

An HTTP function unit 41, an SSL function unit 42, and a socket processing unit 43 are provided in a lower layer of the browser drawing processing unit 30.

The HTTP function unit 41 is a functional part which provides a function for transferring HTML (Hyper Text Markup Language) files and the like, transmitted from the site, to the browser application unit 30 according to a well-known HTTP (Hypertext Transfer Protocol).

The SSL function unit 42 is a functional part which provides a function for providing security of TCP/IP communication by a function of a well-known SSL (Secure Sockets Layer).

The socket processing unit 43 is a functional part which allows the site display function unit 21 of the browser application unit 20 to access TCP/IP (Transmission Control Protocol/Internet Protocol) by a well-known socket interface function, and thus provides a function which allows the site display function unit 21 to obtain the information for displaying the web page provided by the site through TCP/IP communication.

With reference to figures, detailed descriptions are made of functions of the form registration unit 1, the form editing unit 2, and the form using unit 3 included in the mobile phone according to an embodiment of the present invention.

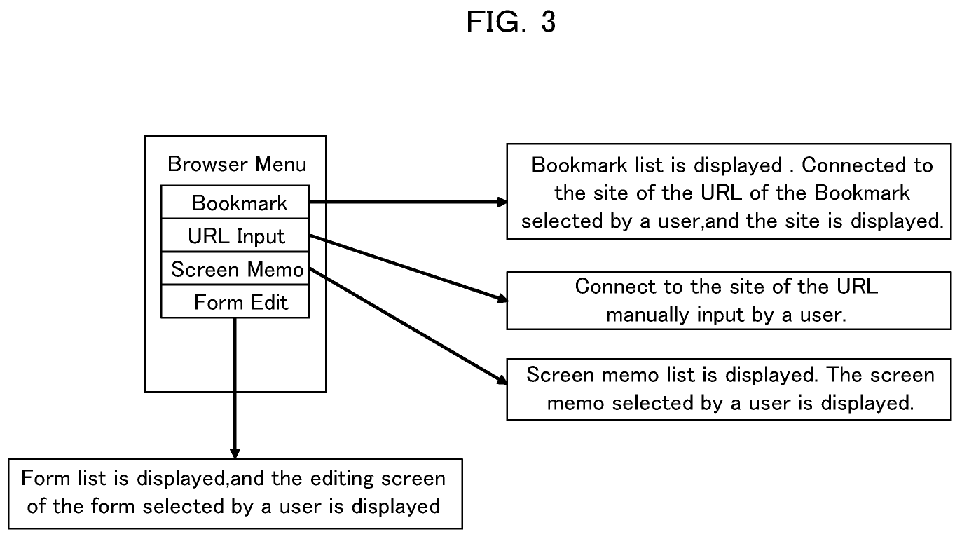

FIG. 3 shows a browser menu included in this mobile phone.

As shown in FIG. 3, the browser menu includes four items: Bookmark, URL Input, Screen Memo, and Form Edit.

Each of the items Bookmark, URL Input, and Screen Memo corresponds to the bookmark function unit 11, the URL input function unit 12, and the screen memo list function unit 13, respectively, as described above and in FIG. 2. If an operation for specifying these items is performed, the following processing is performed.

That is, if an operation for specifying the item Bookmark is performed, a processing for displaying a list of bookmarks registered in advance by the user is performed by the function of the bookmark function unit 11.

If an operation for specifying the item URL Input is performed, a processing for accepting a user's operation for inputting a URL, connecting to the appropriate site, and displaying the web page provided by the site.

If an operation for specifying the item Screen Memo is performed, a processing for displaying a list of screens registered in advance by the user is performed by the function of the screen memo list function unit 13.

In the browser menu shown in FIG. 3, if an operation for specifying the item Form Edit is performed, a processing for displaying the list of the form-input-pages, registered in advance in the form DB and the form DB by the function of the form registration unit 1, is performed by the function of the form list function unit 14.

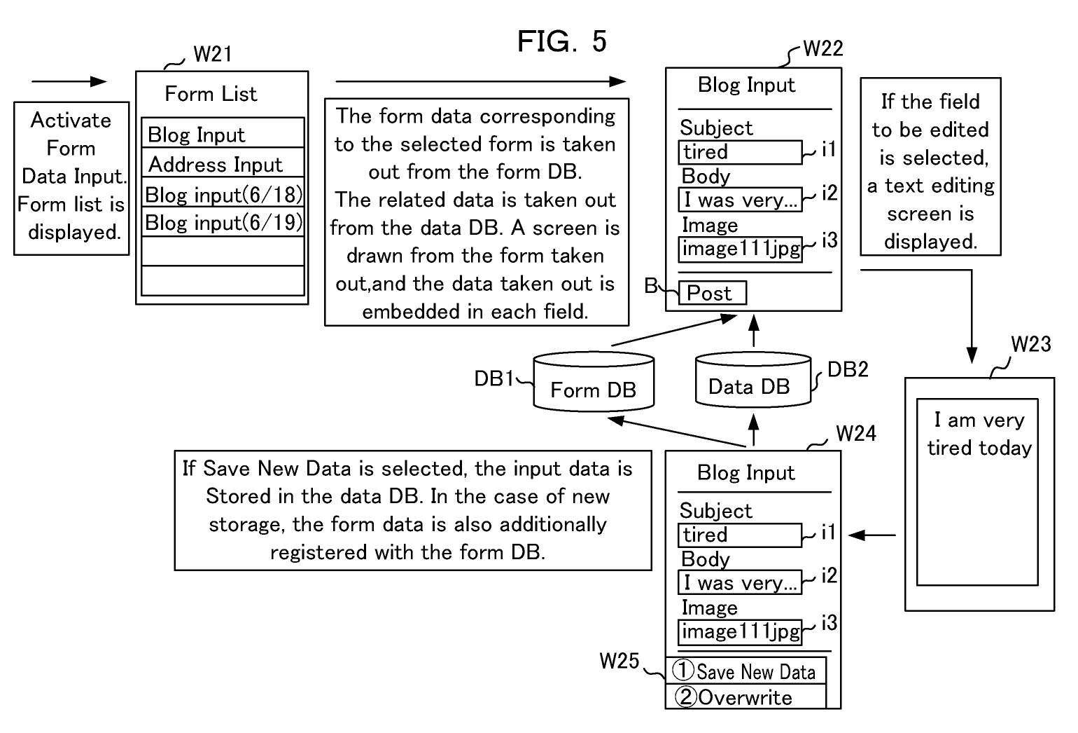

In response to the displaying of the list of the form-input-pages, if an operation for specifying the form-input-page included in the list of the form-input-pages by the user is performed, a processing for displaying the screen for editing the specified form-input-page is performed. This processing is described in detail later with reference to FIG. 5.

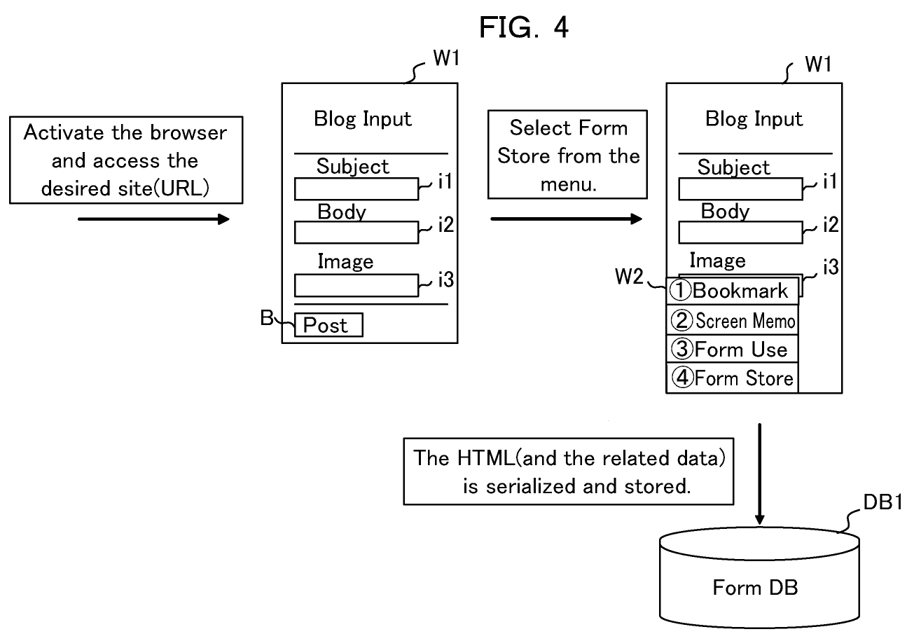

FIG. 4 is a diagram illustrating further details of the function of the form registration unit 1.

In this case, description is made of the case, for example, when a user inputs a blog by using the mobile phone according to an embodiment of the present invention.

First, the user operates the mobile phone to activate the browser and accesses the site of the corresponding blog.

Specifically, if an operation for specifying the item of Bookmark or URL Input from the browser menu shown in FIG. 3 is performed, the bookmark function unit 11 or the URL input function unit 12 described above and in FIG. 2 is activated. Accordingly, a form-input-page W1 (see FIG. 4) for blog input as a web page provided by the site of the corresponding blog is displayed in the online state by each function of the site display function unit 21, the browser drawing processing unit 30, the HTTP function unit 41, the SSL function unit 42, and the socket processing unit 43 (see FIG. 2).

To perform the blog input without using the function of the form registration unit 1, an operation for inputting the data to be transmitted in each of the input items (subject, body, and image) of this form-input-page W1 is performed. After the operation for inputting the data to be transmitted is completed, pressing a “Post” button B shown in the bottom of the form-input-page W1 activates the function of the browser drawing processing unit 30 and the inputted data to be transmitted is uploaded onto the server providing the site of the corresponding blog by an HTTP request. The data to be transmitted inputted by the user, in the form-input-page displayed by the HTML as described above, is displayed in the fields of the input items of the form-input-page. The specific constitution necessary for uploading the data to be transmitted input by the user in the form-input-page onto the server by an HTTP request is the same as that for achieving the function on a conventional browser, so that the description is omitted.

In this case, if the user takes a long time to input the data to be transmitted, a session disconnection may occur as a result of session management of the site of the corresponding blog. If a session disconnection occurs, the connection to the site of the corresponding blog is disconnected, resulting in the offline state, and the data to be transmitted which has been input until that moment may be lost. In such case, the user has to access the site of the corresponding blog and to display the form-input-page W1 for the blog input in the online state in order to start the operation from the beginning.

Description is made of the case of using the function of the form registration unit 1 as follows.

In this case, the user performs an operation for displaying a submenu while the form-input-page W1 for the blog input (see FIG. 4) is displayed. As a result, as shown in FIG. 4, a submenu W2 is displayed overlapping with the form-input-page W1 for the blog input.

As shown in FIG. 4, the submenu W2 includes four items: Bookmark, Screen Memo, Form Use, and Form Store. In this case, if the user performs an operation for specifying the item Form Store, the form-input-page W1 for the blog input is stored and registered in the form DB and the form DB1 by the function of the form registration unit 1. In this case, the HTML files and the related data accompanied, transmitted from the site of the corresponding blog, are serialized and stored in the form DB and the form DB1. As described above, the form-input-page registered in the form DB and the form DB1 is read out from the form DB and the form DB1 by a function of a form editing unit 2 described later and is displayed in the offline state. Therefore, the user can perform an operation for inputting the input items in the form-input-page displayed in a state that the form-input-page is displayed in the offline state in this manner.

Next, description is made of the form editing unit 2 by using FIG. 5.

By the function of the form editing unit 2, the form-input-page registered in the form DB and the form DB1 by the function of the form registration unit 1 described above and in FIG. 4, e.g., the form-input-page W1 in the example of FIG. 4 is read out and displayed in the offline state.

In this case, specifically, the user operates the mobile phone to specify the item Form Edit in the browser menu shown in FIG. 3. As a result, the list of the form-input-pages, registered in advance in the form DB and the form DB1 by the function of the form registration unit 1 as described above (see a form list W21 in FIG. 5), is displayed by the functions of the form list function unit 14, the form edit function unit 23, and the browser drawing processing unit 30 shown in FIG. 2.

In the processing described above and in FIG. 4, the user performs an operation for specifying the form-input-page W1 for the blog input registered in the form DB and the form DB1 by the function of the form registration unit 1 (corresponding to the form called “Blog Input” of the list in the example of the form list W21 of FIG. 5). As a result, the HTML files and the related data accompanied for generating the form-input-page W1, serialized to be stored in the form DB and the form DB1 as described above, are read out. Based on the HTML files and the related data accompanied read out, the form-input-page W1 is generated and displayed in a display unit of the mobile phone by the function of the browser drawing processing unit 30. This function can be achieved by, for example, the same constitution as that of the function of the well-known Screen Memo.

For the form-input-page W1 generated and displayed in this manner, the operation content, which is the same as the operation content performed by the user allowed for the form-input-page W1 displayed as a web page in the online state, is allowed as in the case of generating and displaying the screen stored by the function of the well-known Screen Memo. However, the form-input-page W1 is displayed in the offline state by the function of the form editing unit 2. At this time, therefore, a communication function and a function of an anchor included in the mobile phone become invalid.

Accordingly, with respect to the form-input-page W1 displayed by the function of the form editing unit 2 as described above, the user can input the data to be transmitted in each input item by the operation which is the same as in the case when the data to be transmitted of each input item is input in the form-input-page W1 displayed as a web page in the online state.

After such operation for inputting the data to be transmitted in each input item of the form-input-page W1 displayed in the offline state by the function of the form editing unit 2, if the user performs an operation for storing, the data to be transmitted in each input item is stored and registered as text information in the data DB and the data DB2 in relation to the form-input-page W1.

In this case, the data to be transmitted in each input item is stored in the data DB and the data DB2 in relation to each of the input items of the form-input-page W1, that is, “subject”, “body”, and “image”, respectively.

The above described operation for storing includes operations for saving new data and for overwriting.

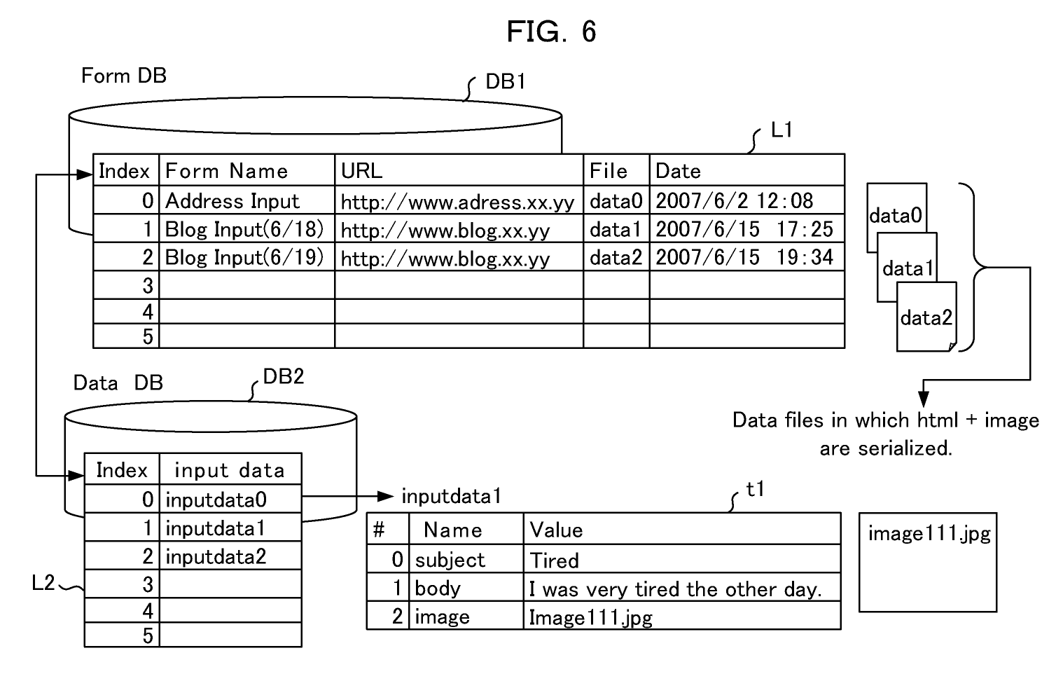

When an operation for saving new data is performed, the data of the corresponding form-input-page (the form-input-page W1 in the example described above) is newly registered in the form DB and the form DB1 in relation to the data to be transmitted at the same time when the data to be transmitted which is input as described above is stored in the data DB and the data BD2. In the case of the saving new data, the data is registered by a name (a name “Blog Input (6/18)” in this example) other than the name “Blog Input”, separately from the original form “Blog Input”, in the form DB and the form DB1. In this case, the data to be transmitted is stored in the data DB and the data DB2 in relation to the form “Blog Input (6/18)” (in the example of FIG. 6 described later, the relation is obtained by matching the index numbers between the data and the form).

In this case as well, the data to be transmitted in each input item is stored in the data DB and the data DB2 in relation to each input item of the form “Blog Input (6/18)” having the same constitution as that of the form-input-page W1 with the original name “Blog Input”, that is, “subject”, “body”, and “image”, respectively.

Meanwhile, when an operation for overwriting is performed, the data to be transmitted is stored in relation to the original form. Therefore, in the case when the operation for overwriting is performed after adding and correcting the data to be transmitted stored in advance in relation to the original form, the original data to be transmitted given the adding and correcting by the overwriting is stored.

As described above, by the operation for inputting the data to be transmitted in each input item of the form-input-page W1 displayed in the offline state by the function of the form editing unit 2, it is possible to change or edit the contents of the data to be transmitted in each input item stored and registered in the data DB and the data DB2 according to need.

With reference to FIG. 5, description is made of the operation in the case of changing or editing the contents of the data to be transmitted in each input item registered in the data DB and the data DB2.

To input the data of each input item to be transmitted, registered in the form DB and the form DB1, in each input item of the form-input-page W1 for the blog input, the user performs the same operation as in the case when the form-input-page for the blog input is read out to be displayed in order to specify the item Form Edit in the browser menu shown in FIG. 3. As a result, the form list W21 registered in advance in the form DB and the form DB1 by the function of the form registration unit 1 is displayed (see FIG. 5) by the functions of the form list function unit 14, the form editing function unit 23, and the browser drawing processing unit 30 shown in FIG. 2. As shown in FIG. 5, the form list W21 includes four names in total: Blog Input, Address Input, Blog Input (6/18), and Blog Input (6/19).

At this time, for example, when the user performs an operation for specifying the form “Blog Input (6/18)” as shown in FIG. 5, the data for displaying the specified form “Blog Input (6/18)” is read out from the form DB and the form DB1. At the same time, the data is related to the form “Blog Input (6/18)”, and the data to be transmitted stored in the data DB and the data DB2 in relation to each of the input items of the form “Blog Input (6/18)”, i.e., “subject”, “body”, and “image”, respectively, is read out from the data DB and the data DB2.

The data for displaying the form “Blog Input (6/18)” read out from the form DB and the form DB1 in this manner is combined with the data to be transmitted read out from the data DB and the data DB2, so that a screen W22 is displayed with the data to be transmitted is embedded in each input item of the form “Blog Input (6/18)” as shown in FIG. 5.

Of the input items, i.e., “subject”, “body”, and “image” displayed in the screen W22 in this state, if an operation for selecting a field of the input item which needs to be changed or edited is performed, a text editing screen W23 is displayed. Then, in this state, the user changes or edits the contents of the data to be transmitted of the input items in a text format according to need. After the data to be transmitted is changed or edited, the user performs an operation for displaying the submenu screen W25 and storing the data to be transmitted with the screen changed or edited. Accordingly, the data to be transmitted with the contents changed or edited is stored in the data DB and the data DB2.

As described above, the data to be transmitted is stored in the data DB and the data DB2 in relation to each input item of the corresponding form “Blog Input (6/18)”, respectively. Therefore, in the case of displaying the form, it is possible to embed the data to be transmitted stored in relation to each input item as the corresponding input item of the form “Blog Input (6/18)”, respectively. In the example of FIG. 6 described later, the data to be transmitted is stored in relation to each input item of the form by relating the data to be transmitted in each input item to the corresponding item of the name attribute of the HTML for displaying the form in which the data is to be embedded.

As a result, the screen W22 of FIG. 5 is displayed in the same state as in the case of the final screen when the data to be transmitted is stored in the data DB and the data DB2. Therefore, when inputting the data to be transmitted by using the function of the form editing unit 2, the user can stop the input operation as needed and can restart the input operation later. In a state that the input operation is interrupted just before the operation is restarted, it is possible to display the data to be transmitted being embedded in each input item of the corresponding form. Therefore, the user friendliness is improved.

In the case of creating a blog, for example, duplication and separate storage of the form are possible, so that it is possible to register a plurality of diaries and articles at one time. By performing an operation for saving new data, it is possible to store the identical form with a different name separately from the original form (such as “Blog Input (6/18)” in the above described example).

FIG. 6 is a diagram illustrating an example of the data to be stored in the form DB, the form DB1, and the data DB, the data DB2, respectively.

The form DB and the form DB1 of FIG. 6 register, for each index number, each name of the form registered, the URL of the site providing the web page of the form-input-page which is an original of the form, the name of the file in which the image files and the like as the HTML data and the related data accompanied for displaying the above described form are serialized and stored, and each of year, month, and day information (“date” in FIG. 6) when the form is registered. At the same time, the files for serializing and storing the image files and the like as the HTML data and the related data accompanied for displaying the above described form are stored in the form DB and the form DB1.

For example, with respect to an index number 1, a file with a file name “data1” is registered, in which the name of the registered form “Blog Input (6/18)”, the URL “http://www.blog.xx.yy” of the site providing the form-input-page W1, the image files and the like as the HTML data and the related data accompanied for displaying the above described form are serialized and stored. The file with the file name “data1” is stored.

On the other hand, in the data DB and the data DB2, the data to be transmitted is stored in relation to each input item of the form in a state that the data to be transmitted is mutually related according to the index number in the form of the list L2 shown in FIG. 6.

For example, as shown in FIG. 6, as the data to be transmitted corresponding to the form with the name “Blog Input (6/18)” of the index number 1, an “inputdata1”, t1 of the same index number 1 is stored in a list form. For the items of the name attribute of the HTML corresponding to each input item in the HTML data for displaying the form, that is, each of the items “subject” (i.e., the input item “subject” of the form-input-page W1 of FIG. 4), “body” (i.e., the input item “body” of the form-input-page W1 of FIG. 4), and “image” (i.e., the input item “image” of the form-input-page W1 of FIG. 4). The “inputdata1”, t1, stores each of the information “Tired”, “I was very tired the other day”, and “image111.jpg” as the data to be transmitted in a list form.

As a result, for example, if the user performs an operation for specifying the “Blog Input (6/18)” in the form list W21 of FIG. 5, the file with the file name “data1”, which is the form with the same file name, that is, the form of the index number1, is read out from the form DB and the form DB1. At the same time, the data “inputdata1”, t1, which is the data to be transmitted of the index number 1 which is the same as that of the index number 1 described above, is read out from the data DB and the data DB2.

While the values “Tired”, “I was very tired the other day”, and “image111.jpg”, included in the data “inputdata1”, for each of the items of the name attribute of the HTML are embedded in the fields “subject”, “body”, and “image” of each input item of the corresponding name attribute in the HTML data included in the above described file “data1”, the screen W22 is displayed by the image file as the HTML data and the related data accompanied. That is, the HTML data included in the file of the file “data1” includes the items of the name attribute in tags of each input item of the form. Therefore, a position in the HTML data is obtained in which the value as the data to be transmitted is to be embedded by collating the item names of the name attribute of the data to be transmitted stored in the data DB and the data DB2 with the item names of the name attribute included in the HTML data. By the drawing processing based on the image file as the HTML data and the related data accompanied which can obtain a position to embed the data to be transmitted, the form is displayed in a state that the data to be transmitted as the corresponding value is embedded in the fields i1, i2, and i3 of each input item as shown in the screen W22 of FIG. 5.

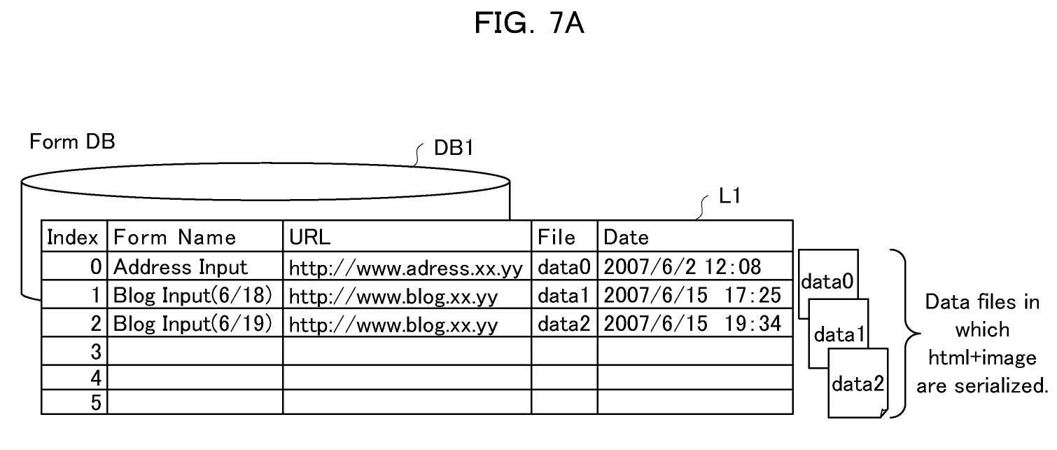

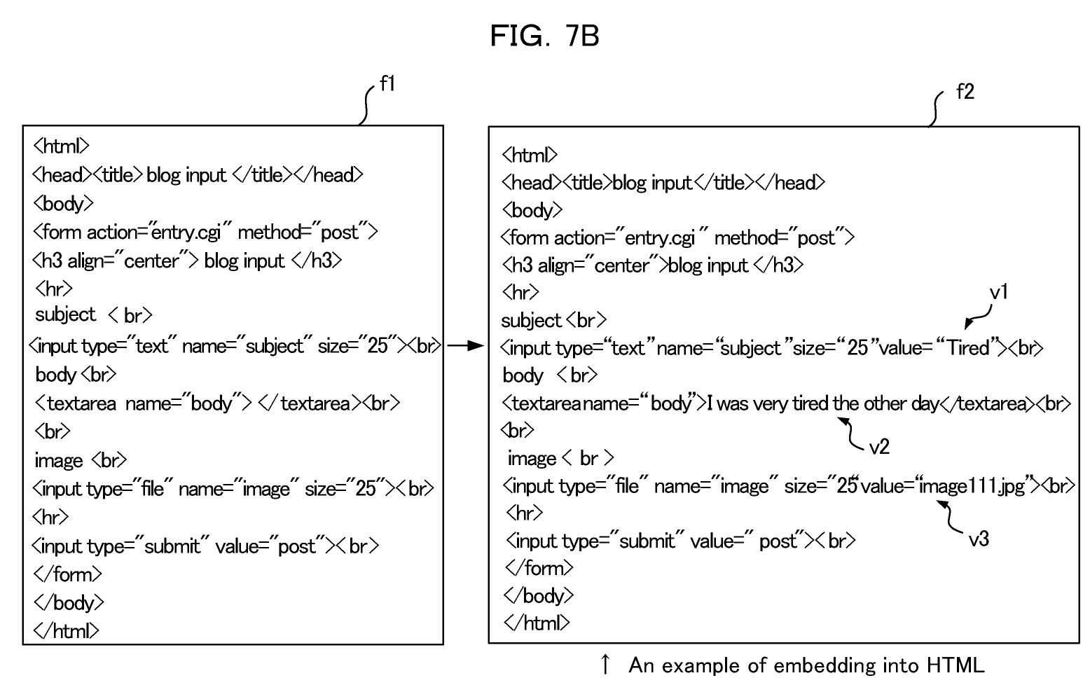

Unlike the method in the case of FIG. 6, FIG. 7A and FIG. 7B are a diagram illustrating a method for omitting the data DB and the data DB2.

In the method of FIG. 7A and FIG. 7B, in the HTML, included in each of the files data0, data1, and data2 and the like in which the image files as the HTML data and the related data accompanied for displaying each form to be stored in the form DB and the form DB1, the corresponding data to be transmitted is embedded in each input item. Therefore, unlike the method in the case of FIG. 6 for storing the data to be transmitted separately from the data for displaying the corresponding form, there is no need to separately store the data to be transmitted. Thus, the data DB and the data DB2 for storing the data to be transmitted become unnecessary.

That is, for example, the information shown in FIG. 7A (i.e., a list L1 and the files data0, data1, and data2 of the substantive data) is stored in the form DB and the form DB1. In this case, in each of the files data0, data1, data2, as shown in FIG. 7B, the information is stored in a state of an HTML data f2 that the corresponding data to be transmitted, v1 “Tired”, v2 “I was very tired the other day”, and v3 “image111.jpg” shown in the right side of FIG. 7B are embedded in the parts of each input item, for example, as shown in the right side of FIG. 7B, of an HTML data f1 for displaying the form shown in the left side of FIG. 7B.

According to the method of FIG. 7A and FIG. 7B, in the case of displaying the screen (the screen W22 in the example of FIG. 5) in which the data to be transmitted is embedded in the form by the function of the form editing unit 2 as described above and in FIG. 5, it is applicable to perform the drawing processing based on the file (the data0, the data1, or the data2 in the example of FIG. 7A and FIG. 7B) for displaying the form stored in the form DB and the form DB1. Like the case of the method of FIG. 6, there is no need for the processing and the like for obtaining a position in which the corresponding data to be transmitted stored in the data DB and the data DB2 is embedded and displayed in the HTML data for displaying the form stored in the form DB and the form DB1.

However, unlike the case of employing the method of FIG. 6, when the method of FIG. 7A and FIG. 7B are employed, the data t1 in a list form (hereinafter referred to as “input item list”) shown in FIG. 6 is not provided as the data to be transmitted. The data to be transmitted in an input item list form is used for the processing for matching the positions in which the data to be transmitted is embedded in the form-input-page displayed as a web page in the online state by the function of the form using unit 3 described later. Therefore, in processing for embedding and displaying the data to be transmitted in the form-input-page displayed as a web page in the online state, there is a need to analyze the HTML data for displaying each form stored in the form DB and the form DB1, to detect the data to be transmitted embedded as each input item of the form, and to make a list of the corresponding input items.

The form DB and the form DB1 can be achieved by the same constitution as that of a database used to achieve the function of the well-known Screen Memo.

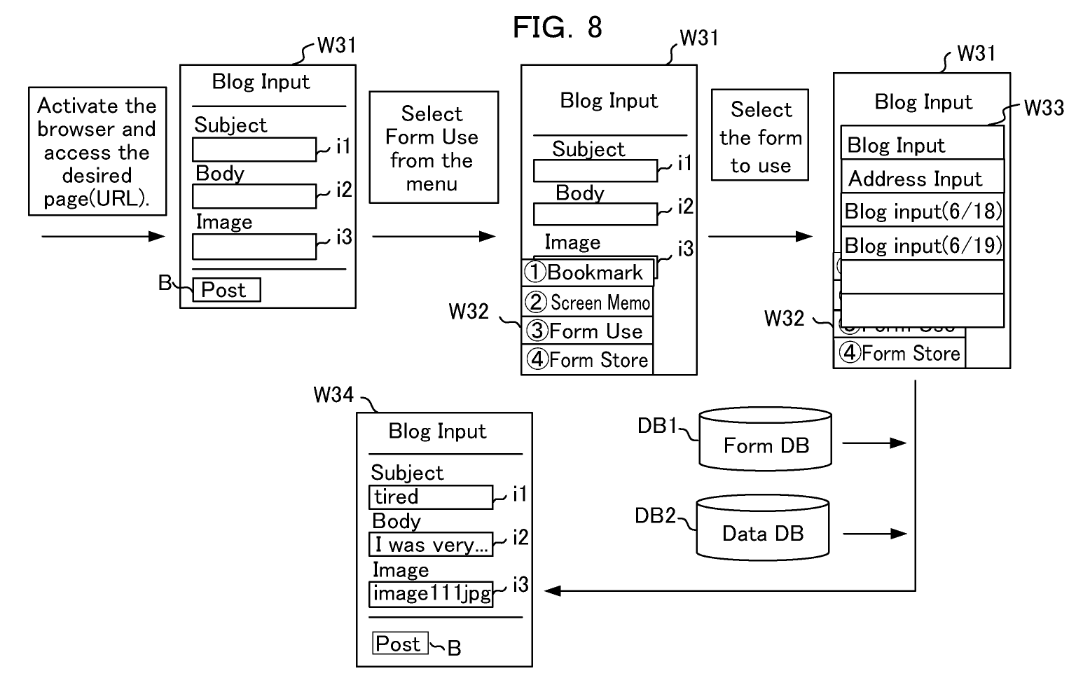

Next, with reference to FIG. 8, description is made of processing for reading out the data to be transmitted stored in the data DB and the data DB2 by the function of the form editing unit 2, and for embedding and displaying the data to be transmitted as the corresponding input item in the form-input-page displayed as a web page in the online state by the function of the form using unit 3.

In this case, first, a form-input-page W31 is displayed as a desired web page by each function of the bookmark function unit 11 or the URL function unit 12, the site display function unit 21, the browser drawing processing unit 30, the HTTP function unit 41, the SSL function unit 42, and the socket processing unit 43. In this example, the form-input-page W31 is a form-input-page for the blog input, which is the same as the form-input-page W1 for the blog input shown in FIG. 4.

The user displays a submenu W32 by performing an operation for displaying the submenu. The submenu W32 has the same constitution as that of the submenu W2 shown in FIG. 4.

In this case, the user performs an operation for selecting the item “Form Use” included in the submenu W32.

As a result, a screen W33 of the form list, which is the same as the screen of the form list W21 shown in FIG. 5, is displayed by each function of the form list function unit 14, the form edit function unit 23, and the browser drawing processing unit 30.

If the user performs an operation for selecting a desired form (the form “Blog Input (6/18) in the example of FIG. 8) from the form list, the data to be transmitted corresponding to the form “Blog Input (6/18)” is read out from the data DB and the data DB2 (in the case of the method of FIG. 6), or the form DB and the form DB1 (in the case of the method of FIG. 7). Then the data to be transmitted is displayed being embedded in each input item field corresponding to the HTML data, the HTML data for displaying the form-input-page W31 currently displayed in the online state, transmitted from the appropriate site when the form-input-page W31 is displayed. Consequently, in the form-input-page W31 currently displayed in the online state, the data to be transmitted stored in advance in the data DB and the data DB2, or the form DB and the form DB1 by using the function of the form registration unit 1 is displayed being pasted in each appropriate input item (i.e., the state of a screen W34 in FIG. 8). In this state, if the user performs an operation for pressing the “Post” button B shown in the bottom of the screen W34, as in the case when the user performs a direct operation for inputting the data to be transmitted in the form-input-page displayed in the online state by a conventional method, the data to be transmitted set in relation to the fields i1, i2, and i3 of each input item of the form is uploaded onto the server by an HTTP request.

That is, in the conventional method, the data to be transmitted is directly inputted in each input item field in a text format while the form-input-page is displayed in the online state. Meanwhile, in an embodiment of the present invention, to obtain the same effect as in the conventional method, the data to be transmitted in a text format, stored in advance in the data DB, the data DB2, or the form DB, the form DB1 by the function of the form editing unit 2, is set as the value of each input item corresponding to the HTML data transmitted from the appropriate site in order to display the form-input-page W31 currently displayed.

In this case, of the forms registered in the form DB and the form DB1, it is preferable that the form can be selected from the form list in the screen W33 of FIG. 8 only if each item of the name attribute corresponding to each input item which exactly corresponds with each item of the name attribute corresponding to each input item of the HTML data for displaying the form-input-page displayed in the online state.

Further, the data to be transmitted read out from the data DB and the data DB2, or the form DB and form DB1 is pasted and displayed in the form-input-page W31 currently displayed in the online state. At this time, the position in which the data to be transmitted is to be embedded in the HTML data transmitted from the site is specified in order to display the form-input-page W31. When the data to be transmitted is displayed being embedded in the position, the processing for specifying the position in which the data to be transmitted is to be embedded is performed for each item of the name attribute corresponding to each input item.

Moreover, in the form-input-page currently displayed in the online state, what can be displayed in a state that the data to be transmitted, is only the input items.

Objects to be uploaded in relation to the form-input-page include the data to be transmitted in a text format, the data to be transmitted as a file, that is, an image file (e.g., the above described “image111.jpg”) and the like. For example, in the case of uploading an image file, the image file can be transmitted as an attached file.

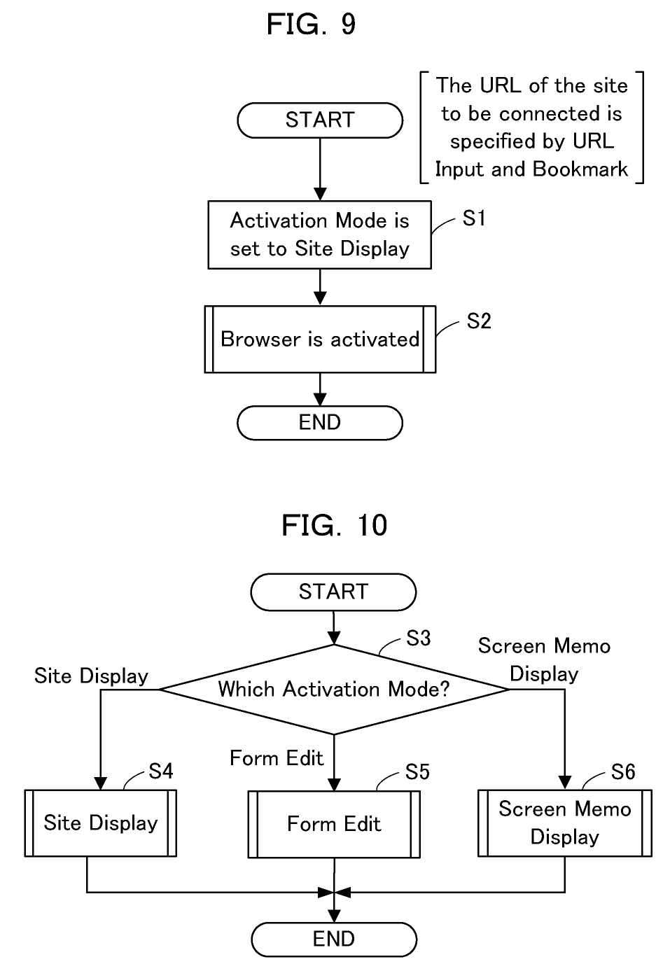

FIG. 9 to FIG. 18 illustrate detailed description of the processing of the mobile phone performed in the case of performing a function by the form input registration unit 1, performing a function by the form editing unit 2, and performing a function of form input using unit 3.

FIG. 9 to FIG. 11 show a flow of processing for displaying the web page by the site display function unit 21.

In FIG. 9, when the URL of the site to be accessed is specified by the function of the bookmark function unit 11 or the URL input function unit 12, the site display function unit 21 of the function units included in the browser application unit 20 is set as an activate mode (step S1). Then the browser application unit 20 is activated (step S2).

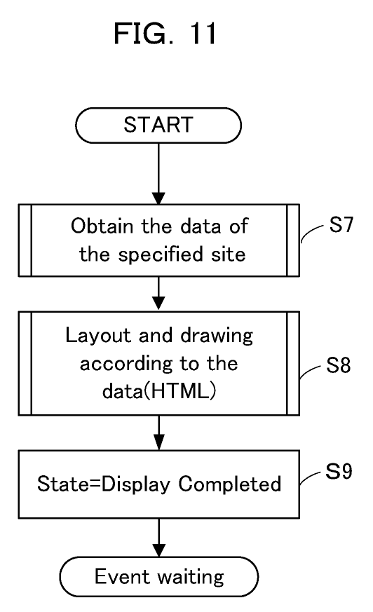

Next, in FIG. 10, when the browser application unit 20 is activated in this manner, the activate mode is determined (step S3). In this case, the processing of FIG. 11 is performed because the site display function unit 21 is set as the activate mode in step S1.

In FIG. 11, in step S7, the site display function unit 21 accesses an appropriate site by each function of the HTTP function unit 41, the SSL function unit 42, and the socket processing unit 43 based on the URL of the site to be accessed, specified as described, and obtains the HTML data and the related data accompanied for displaying a web page from the site. In step S8, the drawing processing of the web page is performed by the browser drawing processing unit 30 according to the HTML data. After the drawing processing of the web page is completed, “Display Completed” is set as a value state relating to the display (step S9).

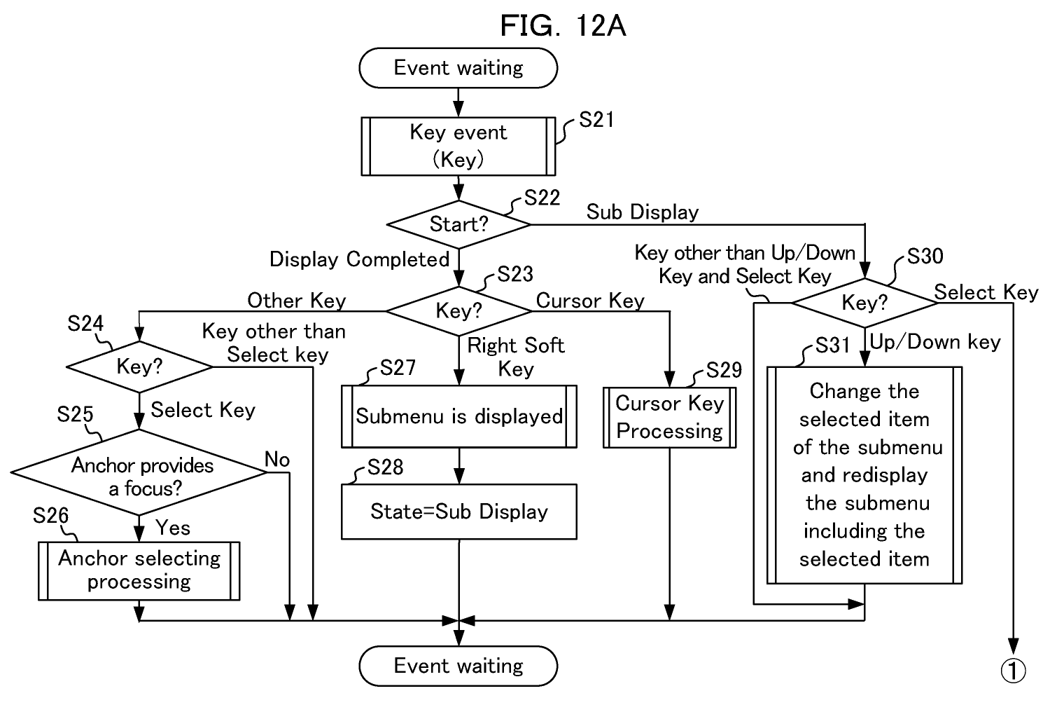

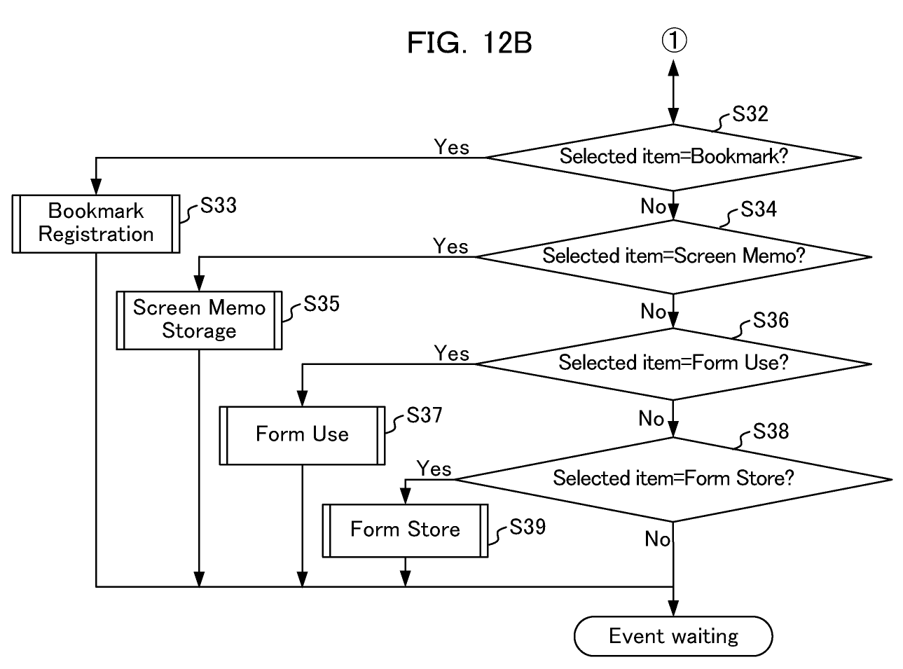

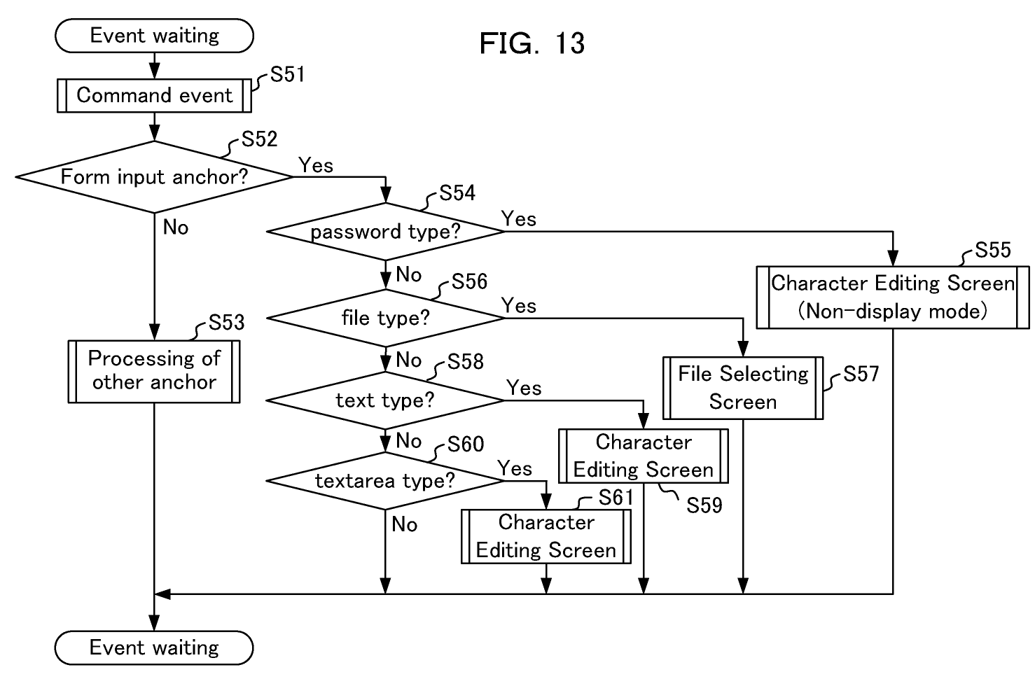

Next, with reference to FIG. 12, description is made of a flow of processing for displaying the submenu while the web page is displayed as described above.

If pressing a predetermined key on the mobile phone by a user causes a key event, setting of the value state relating to the displaying is determined (step S22). If the setting of the value state is “Display Completed”, the predetermined key pressed in step S21 is determined (step S23).

If the predetermined key is a “Right Soft” key, the submenu is displayed (step S27), and “Sub Display” is set to the value state (step S28). The submenu displayed in this case is either the submenu W2 shown in FIG. 4 or the submenu W32 shown in FIG. 8.

If the predetermined key is a cursor key, predetermined cursor key processing is performed (step S29). Specifically, in this case, processing for moving the cursor displayed in the display unit is performed according to the operation by the cursor key.

The predetermined key is a key other than the above described keys, it is determined whether or not that key is a “Select” key (step S24). If this key is the “Select” key, it is determined whether or not an anchor displayed in the display unit provides a focus. That is, for example, it is determined whether or not the display is in a reversed display state because the cursor is located in the anchor (step S25). Specifically, if the anchor provides a focus, processing for displaying the data of the link by the anchor is performed (step S26).

As a result of the determination of the setting of the value state in step S22, the predetermined key pressed in step S21 is determined in step S30 if the setting is “Sub Display”.

If the predetermined key is an “Up/Down” key, the item selected on the submenu currently displayed is changed according to the operation performed on the “Up/Down” key, and the submenu is redisplayed with the item changed (step S31).

If the predetermined key is the “Select” key and if the item selected on the submenu currently displayed is “Bookmark”, processing for registering the URL of the web page currently displayed as a bookmark is performed (step S32 and step S33).

If the predetermined key is the “Select” key and if the item selected on the submenu currently displayed is “Screen Memo”, processing for storing the web page currently displayed is performed by the function of the screen memo (step S34 and step S35).

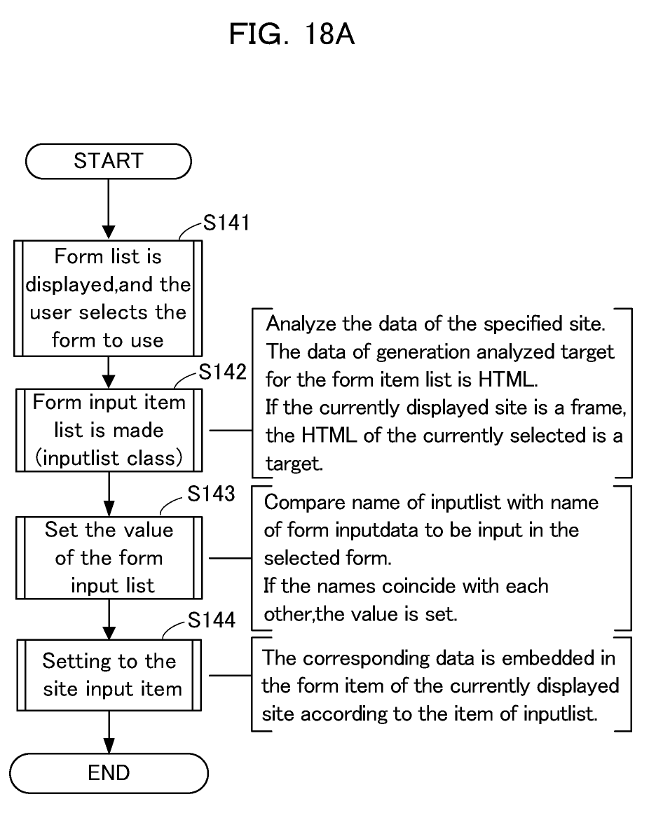

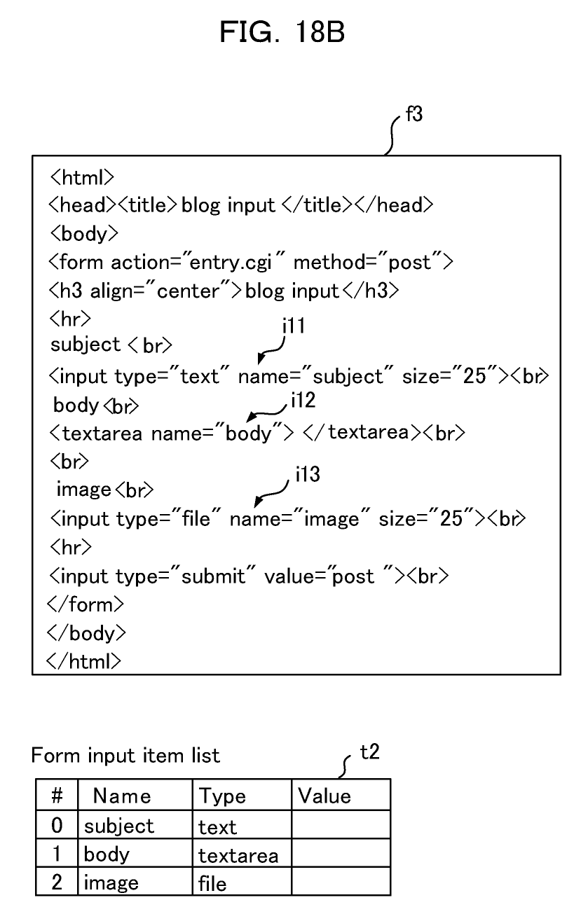

If the predetermined key is the “Select” key and if the item selected on the submenu currently displayed is “Form Use”, the function of the form using unit 3 described later in FIG. 18 is performed (step S36 and step S37).

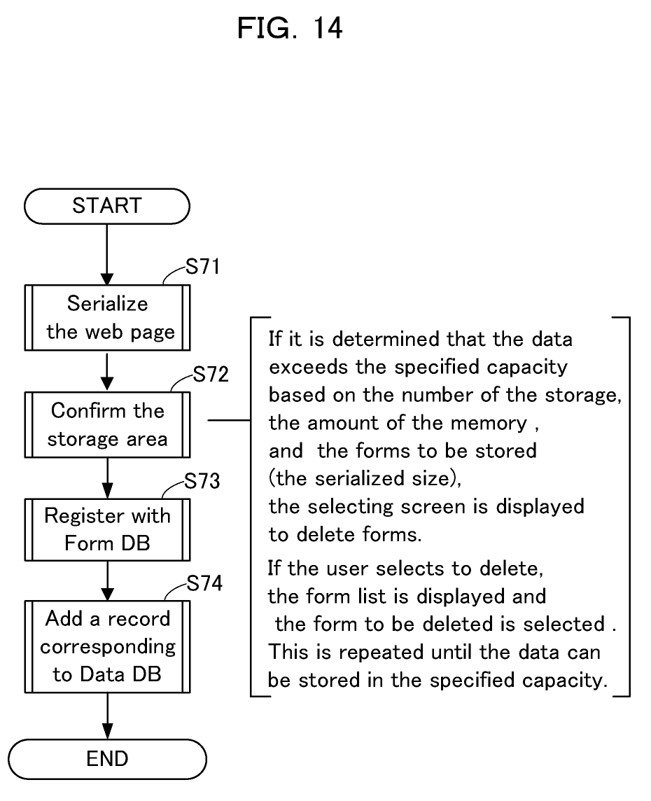

If the predetermined key is the “Select” key and if the item selected on the submenu currently displayed is “Form Store”, the function of the form registration unit 1 described later in FIG. 14 is performed (step S38 and step S39).

With reference to FIG. 13, description is made of a flow of processing of transition of the display content occurred in the case of specifying a predetermined part on the image displayed while the web page is displayed.

If the predetermined key is pressed, a command event occurs (step S51).

It is determined whether or not the part currently specified on the displayed image is a “Form Input” anchor (step S52).

If the part currently specified on the displayed image is an anchor other than the “Form Input” anchor, the processing for displaying the data of the link by the specified anchor is performed.

If the part currently specified on the displayed image is the “Form Input” anchor and if the “Form input” anchor is for inputting a password, a character editing screen is displayed in a non-display mode (step S54 and step S55). That is, even though the field in which the user can input the data in a text format is displayed, the display is in the non-display mode in this case, so that the characters input by the user actually appear as asterisks, and the specific input contents are hidden.

If the part currently specified on the displayed image is the “Form Input” anchor and if the “Form Input” anchor is for setting files, a file selecting screen is displayed (step S56 and step S57). Of the input items provided on the form-input-page W1 shown in FIG. 4, the “Form Input” anchor for setting files is part of the field i3 for inputting image file names. If this anchor is specified, a list of specifiable image files registered in advance is displayed to allow the user to select the image file. At this time, the file name of the image file selected by the user is set to the field i3.

If the part currently specified on the displayed image is the “Form Input” anchor and if the “Form Input” anchor is for inputting data in a text format, a character editing screen is displayed (step S58 and step S59). The “Form Input” anchor for setting the data in a text format is, for example, part of the field i1 for inputting a subject of the input items provided on the form-input-page W1 shown in FIG. 4. If this anchor is specified, a field of a predetermined size in which the user can input the data in a text format, that is, characters and the like is displayed. At this time, the data in a text format input by the user is set to the field i1.

If the part currently specified on the displayed image is the “Form Input” anchor and if the “Form Input” anchor is for inputting the data in a text format over a plurality of lines, the character editing screen is displayed (step S60 and step S61). Of the input items provided on the form-input-page shown in FIG. 4, the “Form input” anchor for setting the data in a text format over a plurality of lines is, for example, part of the field i2 for inputting a body of the input items provided on the form-input-page W1 shown in FIG. 4. If this anchor is specified, a filed of a predetermined size in which the user can put the data in a text format, that is, characters and the like over a plurality of lines is displayed. At this time, the data in a text format input by the user is set to the field i2.

With reference to FIG. 14, description is made of processing for performing a function of the form registration unit 1.

In step S71, the HTML data displaying the web page currently displayed in the online state and the related data accompanied are serialized.

In step S72, it is determined whether or not all the data can be stored in a range of storage capacity ensured for the form DB and the form DB1 on the memory 4 based on the HTML data and the related data accompanied serialized as described above.

If it is determined that all the data can be stored, in step S73, the file of the HTML data and the related data accompanied serialized are stored in the form DB and the form DB1.

Further, a list L1 stored in the form DB and the form DB1 of FIG. 6 described above is added with a record indicating the stored file (step S74).

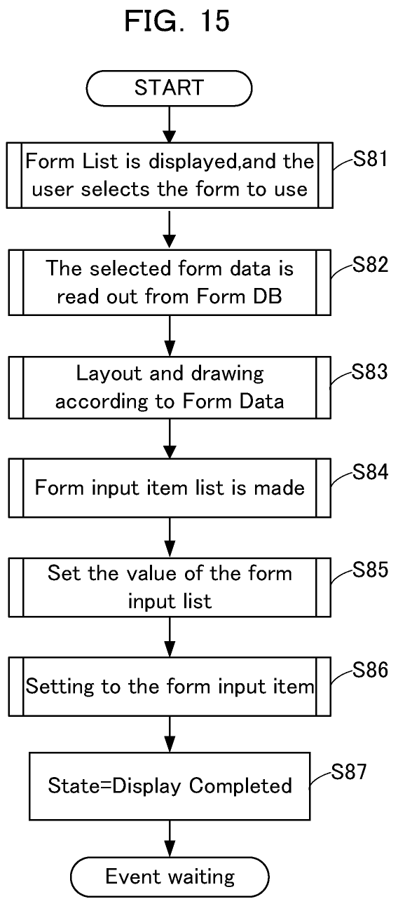

With reference to FIG. 15, description is made of a flow of processing for performing a function of the form editing unit 2.

By performing step S5 of FIG. 10, a form list shown in the screen W21 of FIG. 5 is displayed (step S81).

In response, when the user selects either of the forms, the file including the image files and the like as the HTML data and the related data accompanied for displaying the form is read out from the form DB and the form DB1 (step S82).

The form is displayed based on the read-out file (step S82).

Next, in step S84, the HTML data relating to the displaying of the displayed form is analyzed to make an input item list. The input item list is the same as an input item list t2 shown in FIG. 18B described later. The input item list is made by detecting written parts related to the input items in the HTML data relating to displaying the form. In the case of the example of the input item list t2 of FIG. 18B, the list is made by listing items “subject”, “body”, and “image” of the name attribute of the HTML, and the words, “text”, “textarea”, and “file” indicating each of the corresponding HTML tags <input type=“text” . . . >, <textarea . . . textarea>, and <input type=“file” . . . >.

In step S85, a value with respect to each input item included in the input item list obtained by the listing described above, i.e., the specific data to be transmitted, is set. In the case of the method of FIG. 6, matching of the input items is performed between the input item list and a list t1 stored in the data DB and the data DB2 in relation to the form. Specifically, checking of the name attributes of the HTML is performed. If the items of the name attribute are coincide with each other, it is determined that these input items correspond each other, and the data to be transmitted, which is the value of the corresponding input item of the list t1, is set as the value of the input item corresponding to the input item list.

In step S86, by making the data to be transmitted as the set value to correspond to the part in which the value of the input item is to be set in the HTML data displaying the form displayed in step S83 by using the input item list in which the data to be transmitted is set as the value as described above, the data to be transmitted is displayed being embedded in the appropriate input item field. For example, in the input item list, the data to be transmitted is made to correspond to the parts of the HTML data by the words “text”, “textarea”, and “file” indicating each of the HTML tags <input type=“text” . . . >, <textarea . . . textarea>, and <input type=“file” . . . >, and each of the items “subject”, “body”, and “image” of the name attribute. Then the value, that is, the data to be transmitted, is displayed being embedded with respect to the corresponded part.

As a result of the setting of the value of the data to be transmitted with respect to the part related to the input item of the HTML data displaying the form as described above, the form is displayed while the data to be transmitted in a text format is pasted in the fields i1, i2, and i3 of each input item of the form.

Then the above described value state is set to “Display Completed” (step S87).

The data to be transmitted has not been set yet in the case of performing the function of the form editing unit 2 on the form just registered by the function of the form registration unit 1. Thus, the processing from step S84 to step S86 is skipped, and the input operation of the data to be transmitted is performed by the user to the form displayed in step S83, that is, the form with blank fields for the fields i1, i2, and i3 of each input item (e.g., as in the state of the screen W1 of FIG. 4).

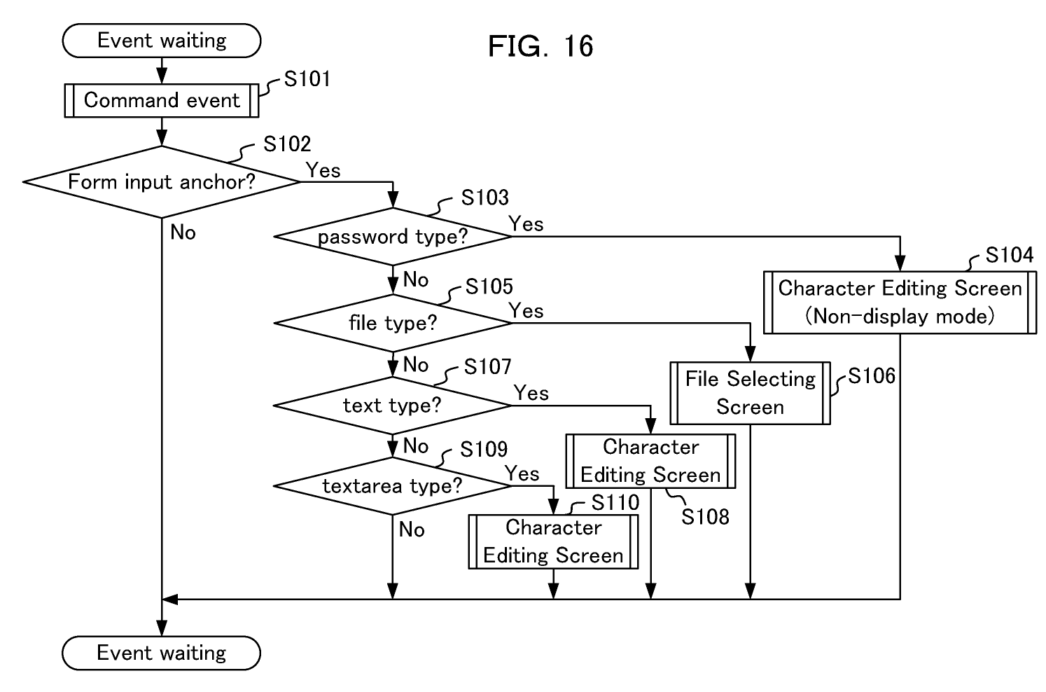

Next, with reference to FIG. 16, description is made of a flow of processing for user's setting of the data to be transmitted to the form displayed as described above, or for performing adding and modifying (that is, editing) on the data to be transmitted, which is set in advance.

Each of step S101, step S102, and step S103 to step S110 in the processing flow shown in FIG. 16 has the same content as that of step S51, step S52, and step S54 to step S61 in the processing flow shown in FIG. 13, respectively. Thus, the duplicate descriptions are omitted.

FIG. 13 illustrates a flow of processing for performing setting the data to be transmitted or for performing adding and modifying (that is, editing) on the data to be transmitted to the form-input-page displayed in the online state. On the other hand, FIG. 16 illustrates a flow of processing for performing setting the data to be transmitted or for performing adding and modifying (that is, editing) on the data to be transmitted to the form-input-page displayed in the offline state. Therefore, anchor processing with a communication function which is valid only in the online state, that is, step S53 of FIG. 13 is excluded in the processing of FIG. 16.

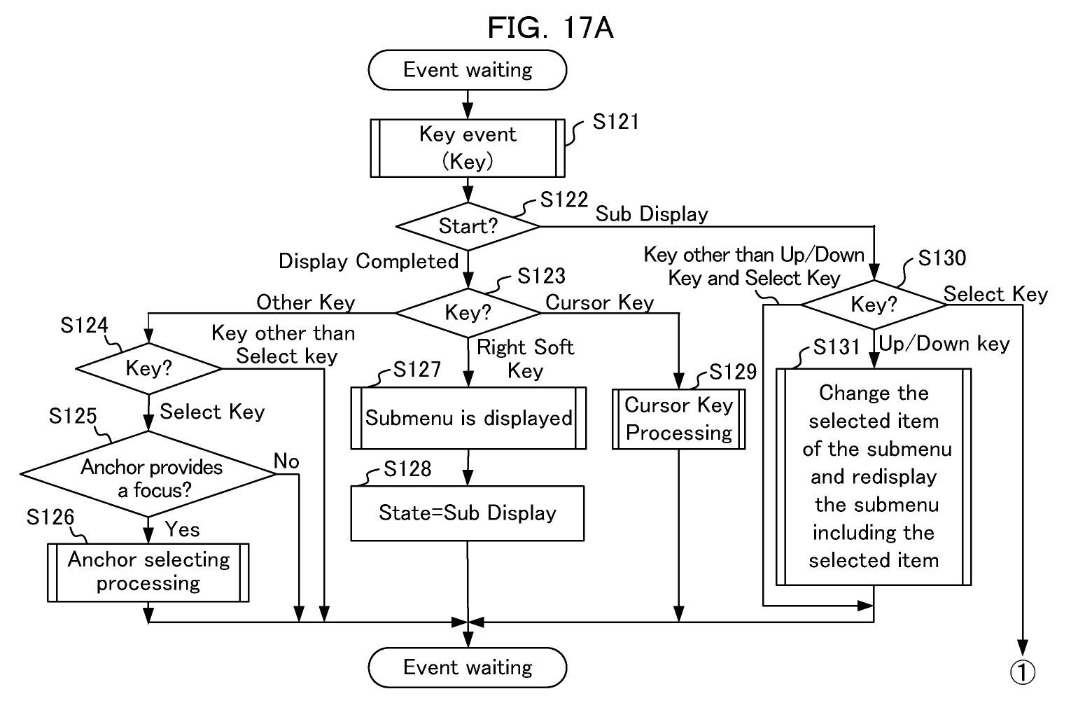

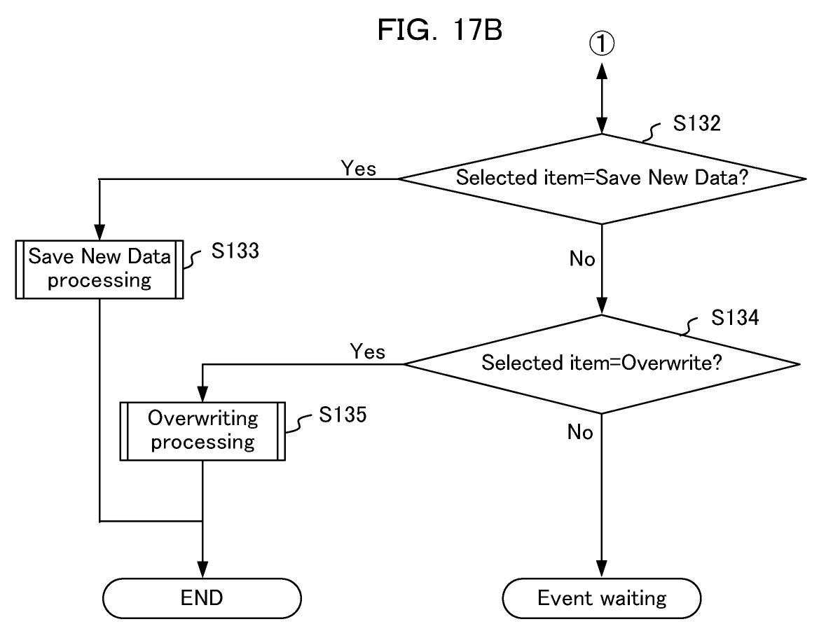

Next, with reference to FIGS. 17A and 17B, a description is made of a flow of processing for storing the data to be transmitted input by the user or the data to be transmitted, given the adding and modifying (that is, editing) in a later stage in the case of performing the function of the form edit function unit 2.

Each of step S121 to step S131 in the processing flow shown in FIG. 17A has the same content as that of each of step S21 to step S31 shown in FIG. 12, respectively. Thus, the duplicated descriptions are omitted.

In step S132, for example, if an item “Save New Data” of the items shown in a submenu W25 shown in FIG. 5 is selected, the processing of saving new data in step S133 is performed (FIG. 17B).

In step S134, in the above described case, if an item “Overwrite” of the items shown in the submenu W25 shown in FIG. 5 is selected, the processing for overwriting in step S135 is performed.

The processing for saving new data and overwriting is the processing described above respectively as the processing performed in the case of performing the operations for saving new data and overwriting.

Next, with reference with FIG. 18A, description is made of a flow of processing for performing a function of the form using unit 3. By the processing described above and shown in FIG. 8, the form-input-page (the form-input-page W31 in the example of FIG. 8) in which the user attempts to set the data to be transmitted by the function of the site display function unit 21 and the like is displayed in the online state.

After that, the user displays the form list (the screen W33 of the form list in the example of FIG. 8) by the processing described above and in FIG. 8, and selects the form corresponding to the data to be transmitted (step S141).

Next, an HTML data f3, the HTML data related to displaying the form-input-page displayed in the online state as described above, transmitted from the appropriate site by the function of the site display function unit 21 and the like, is analyzed to make an input item list (step S142).

This input item list is, for example, the input item list t2 shown in FIG. 18B. The input item list is made by detecting the parts related to the input items in the HTML data relating to the displaying of the form. In the case of the example of the input item list t2 of FIG. 18B, the input item list t2 is made by listing each of the items “subject”, “body”, and “image” of the name attribute of the HTML, and the words “text”, “textarea”, and “file” indicating each of the corresponding HTML tags, <input type=“text” . . . >, <textarea . . . textarea>, and <input type=“file” . . . >.

In step S143, the value with respect to each of the input items included in the input item list t2 obtained by the listing as described above, that is, the specific data to be transmitted is set. In the case of the method of FIG. 6, matching of the input items is performed between the input item list and the input item list t1 stored in the data DB and the data DB2 in relation to the form. Specifically, checking of the name attributes of the HTML is performed to determine that the input items are corresponded if the name attributes are coincident with each other. Then the data to be transmitted as the value of the input item in the list t1 is set as the value of the corresponding input item in the input item list.

In step S144, by using the input item list in a state that the data to be transmitted is set as the value, the data to be transmitted set as the value is made to correspond with the part in which the value of the input item is to be set (that is, the part to be embedded) of the HTML data f3 displaying the form displayed in the online state. For example, parts i11, i12, and i13 of the HTML data are obtained by the words “text”, “textarea”, and “file” indicating each of the HTML tags <input type=“text” . . . >, <textarea . . . textarea>, and <input type=“file” . . . >, and each of the items “subject”, “body”, and “image” indicating the name attribute as keys. Then, in the part obtained, with respect to the part in which the value as the data to be transmitted is to be set, displaying is performed in a state that the value, that is, the data to be transmitted is embedded therein.

As a result, it is possible to obtain the same state as in the case when the user performs the operation for directly inputting the data to be transmitted in the form-input-page displayed in the online state by the conventional method.

In the case of the conventional method, that is, in the case when the user directly inputs the data to be transmitted in a text format in the form-input-page displayed in the online state and performs an operation for pressing the post button (corresponding to the post button B of FIG. 8 in the above described embodiment) in this state, the input item list which is the same as the input item list t2 is made as well in the case when the data to be transmitted input by the user is uploaded onto the server by an HTTP request. In this case, the data to be transmitted as the value set to the input item list is uploaded onto the server by the function of the browser (corresponding to the browser drawing processing unit 30 of FIG. 2 in the above described embodiment).

The description of FIG. 18A is made again. As described above, the data to be transmitted as the value for the input item list t2 is set in step S143 and is displayed being embedded in the fields i1, i2, and i3 of the corresponding input items of the form-input-page. After the user sees this displaying and confirms the content of the data to be transmitted, the user performs an operation for pressing the post button B. Consequently, as in the above described conventional method, the data to be transmitted as the value set to the input item list t2 by the function of the browser drawing processing unit 30 is uploaded on the server.

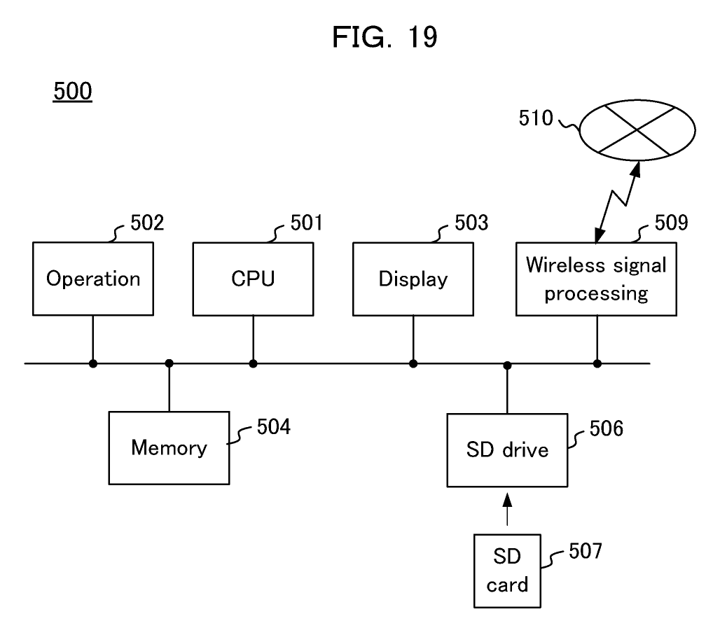

FIG. 19 is a block diagram showing a constitution example of a computer which controls operations of the mobile phone according to the above described embodiment of the present invention.

As shown in FIG. 19, a computer 500 includes a CPU 501 for performing various operations by performing instructions included in given programs; an operation unit 502 including a keyboard, a mouse and the like for inputting operation contents or data by a user; a display unit 503 including a CRT, a liquid crystal display (LCD) instrument and the like for displaying processing processes; processing results and the like by the CPU 501 to the user, a memory 4 used as a storage area for storing programs, data and the like performed by a CPU 504 including a ROM, a RAM and the like; an SD card drive 506 for loading programs or data from outside through an SD card 507 or a wireless communication network 510; a wireless signal processing unit 509 for performing download of data to display a web page from an external server through a wireless communication network 510, upload of the data to be transmitted set to the form-input-page as a web page, and download of various programs.

The computer 500 loads or downloads the programs including instructions for making the CPU 501 perform the processing for performing, through the SD card 507, each of the function of the form registration unit 1 performed by the mobile phone, the function of the form editing unit 2, and the function of the form using unit 3 according to above described embodiment. Then the programs are loaded on a memory 504 and performed by the CPU 501. As a result, the computer 500 performs each processing of the mobile phone according to the above described embodiment of the present invention.

The description has been made of the embodiments of the case when an information processing apparatus according to the present invention is a mobile phone. However, the information processing apparatus according to the present invention is not limited to a mobile phone. The embodiment is applicable to all electronic devices having a function for uploading the data to be transmitted onto the server by using a form-input-page. For example, the information processing apparatus according to the present invention is applicable to, for example, personal computers, information home electronic appliances and the like.

However, the present invention is favorable particularly for an information processing apparatus having constitution that the input operation of characters and the like is relatively difficult because, for example, the character editing screen cannot be large enough in the case of inputting the data to be transmitted. This is because that the size of the apparatus has to be smaller like a mobile phone to be easily carried by users.

What is claimed is:

1. An form input support method for supporting to input data in a form-input-page displayed as a webpage, in constitution for inputting data to be transmitted in each input item, wherein a screen storage function unit comprises:
a step for storing screens to store the form-input-page displayed as the web page, a data edit function unit comprises,
a step for editing data to display the form-input-page stored by the step for storing screens in an offline state and stores the data to be transmitted input in each input item in relation to the form-input-page, a data paste function unit comprises a step for taking out the data to be transmitted stored in relation to the form-input-page in the step for editing data, and for pasting and displaying the data to be transmitted in an input item of a corresponding form-input-page displayed as a web page in the online state.

2. The form input support method according to claim 1, the form input support method has constitution that the form-input-page is stored in an HTML format in the step for storing screens.

3. The form input support method according to claim 1, wherein the step for pasting data comprises a step for setting the data to be transmitted to each input item and a step for pasting the data to be transmitted set to each input item in the step for setting.

4. The form input support method according to claim 3, wherein the input item is provided as a name attribute of an HTML, and the step for setting and the step for pasting are performed in item units of the name attribute of the HTML corresponding to each input item.

5. The form input support method according to claim 4, wherein the step for pasting data has constitution that the data to be transmitted is pasted in the form-input-page displayed as a web page only if all the items of the name attribute of the HTML, corresponding to the input item of the data to be transmitted stored by the step for editing data, coincides with all the items of the name attribute of the HTML corresponding to the input item of the form-input-page displayed as the web page.

6. The form input support method according to claim 1, wherein the step for editing data has constitution that the data to be transmitted once stored in relation to the form-input-page is displayed in the input item of the form-input-page and thus can be edited.

7. An information processing apparatus that has a function for supporting to input data in a form-input-page having constitution that data to be transmitted is input in each input item, the information processing apparatus comprising:
a screen storing unit that stores a form-input-page displayed as a web page;
a data editing unit that displays the form-input-page stored by the screen storing unit in an online state and stores the data to be transmitted input in each of the input items in relation to the form-input-page; and
a data pasting unit that takes out the data to be transmitted stored by the data editing unit in relation to the form-input-page and pastes and displays the data to be transmitted in the input item of the corresponding form-input-page displayed as a web page in an online state.

8. The information processing apparatus according to claim 7, the screen storing unit has constitution that the form-input-page is stored in an HTML format.

9. The information processing apparatus according to claim 7, wherein the data pasting unit has constitution that the data to be transmitted is set to each input item, and the data to be transmitted set to each input item is pasted and displayed in a corresponding input item of the form-input-page displayed as a web page.

10. The information processing apparatus according to claim 9, wherein the input item is provided as an attribute of an HTML, and the data pasting unit has constitution that the data to be transmitted is pasted and displayed in the input item of the form-input-page displayed as a web page in item units of the name attribute of the HTML corresponding to each input item.

11. The information processing apparatus according to claim 10, wherein the data pasting unit has constitution that the data to be transmitted is pasted and displayed in the form-input-page displayed as a web page only if the items of the attribute of the HTML corresponding to the input item of the data to be transmitted stored by the data editing unit coincide with all of the items of the attribute of the HTML corresponding to the form-input-page displayed as a web page.

12. The information processing apparatus according to claim 7, the data editing unit has constitution that the data to be transmitted once stored in relation to the form-input-page is pasted and displayed in the input item of the form-input-page, and thus the data to be transmitted can be edited.

13. The information processing apparatus according to one of claims 7, wherein the information processing apparatus comprises a mobile phone.
